(19) United States
(12) Patent Application Publication
(10) Pub. No.: US 2025/0044880 A1
(43) Pub. Date: Feb. 6, 2025

(54) Handheld Input Devices

(71) Applicant: Apple Inc., Cupertino, CA (US)

(72) Inventor: Paul X Wang, Cupertino, CA (US)

(21) Appl. No.: 18/363,560

(22) Filed: Aug. 1, 2023

(51) Int. Cl. G06F 3/03; G06F 3/01; G06F 3/0346; G06T 7/73

(52) U.S. Cl. CPC G06F 3/0308; G06F 3/016; G06F 3/0346; G06T 7/73; G06T 2207/30204

(57) ABSTRACT

A system may include an electronic device such as a head-mounted device and a handheld input device for controlling the electronic device. A lanyard may be removably attached to the handheld input device or a non-electronic object. The lanyard may include visual markers, such as infrared light-emitting diodes and/or fiducials, that can be detected by an external camera and used to track a location of the lanyard. For example, the lanyard may be fabric, and the visual markers may be incorporated into the fabric or attached to the fabric. The lanyard may also include motion sensors, visual-inertial odometry cameras, or other sensors to determine the location of the lanyard. The lanyard may be electrically coupled to the handheld input device, such as to transfer power and/or data. Alternatively, the lanyard may be coupled to a non-electronic object and may include a battery and/or a haptic output component.

### FIELD

This relates generally to computer systems and, more particularly, to input devices for computer systems.

### BACKGROUND

Electronic devices such as computers can be controlled using an input device. For example, an electronic device may be controlled using a mouse, trackpad, and/or keyboard.

### SUMMARY

A system may include an electronic device such as a head-mounted device and a handheld input device for controlling the electronic device. The head-mounted device or other device may have a display configured to display virtual content that is overlaid onto real-world content.

A lanyard may be removably attached to the handheld input device. The lanyard may include visual markers, such as infrared light-emitting diodes and/or fiducials, that can be detected by an external camera and used to track a location, orientation, and/or motion of the lanyard. For example, the lanyard may be fabric, and the visual markers may be incorporated into the fabric or attached to the fabric. The external camera may then take images of the visual markers, and image recognition may be used to track the visual markers and therefore to track the lanyard.

The lanyard may alternatively or additionally include motion sensors, visual-inertial odometry cameras, or other sensors to determine the location of the lanyard. The lanyard may communicate its location to the head-mounted device and/or the handheld input device over a wired or wireless connection.

The lanyard may be electrically coupled to the handheld input device, such as to transfer power and/or data. For example, the lanyard may be electrically coupled to the handheld input device over a USB-C port, lightning port, or other port.

Alternatively, the lanyard may be coupled to a non-electronic object and may additionally include a battery and/or a haptic output component.

### BRIEF DESCRIPTION OF THE DRAWINGS

FIG. 1 is a schematic diagram of an illustrative system with a handheld input device and an associated external device in accordance with some embodiments.

FIG. 2 is a perspective view of an illustrative handheld input device in accordance with some embodiments.

FIG. 3 is a front view of an illustrative handheld input device with a lanyard having visual markers in accordance with some embodiments.

FIG. 4A is a front view of an illustrative handheld input device with a lanyard that can be curved into a desired shape in accordance with some embodiments.

FIGS. 4B and 4C are front views of illustrative stiffening structures that may be used to form a lanyard so that the lanyard can keep a desired shape in accordance with some embodiments.

FIG. 4D is a perspective view of an illustrative handheld input device with a lanyard that is curved into a loop shape in accordance with some embodiments.

FIG. 5 is a perspective view of an illustrative system that includes a head-mounted device with a camera that can track a lanyard with visual markers in accordance with some embodiments.

FIGS. 6A and 6B are views of an illustrative handheld input device with a lanyard attached on both ends in accordance with some embodiments.

FIGS. 7A and 7B are views of an illustrative handheld input device with a lanyard having light emitters on multiple surfaces in accordance with some embodiments.

FIG. 8 is a side view of an illustrative handheld input device with a lanyard having a visual-inertial odometry camera in accordance with some embodiments.

FIG. 9 is a perspective view of an illustrative handheld input device with a lanyard that wraps around a body part of a user in accordance with some embodiments.

### DETAILED DESCRIPTION

Electronic devices that are configured to be held in the hand of a user may be used to gather user input and to provide a user with output. For example, electronic devices that are configured to control one or more other electronic devices, which are sometimes referred to as controllers, handheld controllers, input devices, or handheld input devices, may be used to gather user input and to supply output. An input device may, as an example, include an inertial measurement unit with an accelerometer for gathering information on input device motions such as swiping motions, waving motions, writing movements, drawing movements, shaking motions, rotations, etc., may include wireless communications circuitry for communicating with external equipment such as a head-mounted device, may include tracking features such as active or passive visual markers that can be tracked with an optical sensor in an external electronic device, may include input devices such as touch sensors, force sensors, buttons, knobs, wheels, etc., and/or may include sensors for gathering information on the interactions between the handheld input device, the user's hands interacting with the input device, and the surrounding environment. The handheld input device may include a haptic output device to provide the user's hands with haptic output and may include other output components such as one or more speakers.

One or more handheld input devices may gather user input from a user. The user may use the input devices to control a virtual reality, augmented reality, or mixed reality device (e.g., head-mounted equipment such as glasses, goggles, a helmet, or other device with a display). During operation, the input device(s) may gather user input such as information on interactions between the input device(s) and the surrounding environment, interactions between a user's fingers or hands and the surrounding environment, and/or interactions associated with virtual content displayed for a user. The user input may be used in controlling visual output on a display (e.g., a head-mounted display, a computer display, etc.). Corresponding haptic output may be provided to the user's fingers using the input device. Haptic output may be used, for example, to provide the fingers of a user with a desired sensation (e.g., texture, weight, torque, pushing, pulling, etc.) as the user interacts with real or virtual objects using the handheld input device. Haptic output can also be used to create detents, to provide localized or global haptic feedback in response to user input that is supplied to the input device, and/or to provide other haptic effects.

Input devices can be held in one or both of a user's hands, or may otherwise be coupled to a user. Users can use the input devices to interact with any suitable electronic equipment. For example, a user may use one or more input devices to interact with a virtual reality or mixed reality system (e.g., a head-mounted device with a display), to supply input to a desktop computer, tablet computer, cellular telephone, watch, ear buds, or other accessory, to control household items such as lighting, televisions, thermostats, appliances, etc., or to interact with other electronic equipment.

A lanyard may be used to convert items into input devices and/or to enhance the input-output capabilities of electronic input devices. The lanyard may include input-output components, sensors, and/or other circuitry and may be configured to be coupled to an item that may or may not contain any electronics or circuitry. Alternatively or additionally, the lanyard may include visual markers, such as light emitters (e.g., infrared LEDs) and/or fiducials, that are tracked by a camera in an associated external device, such as a head-mounted device. In this way, the head-mounted device may track the visual markers to determine the location, orientation, and/or motion of the lanyard.

In some arrangements, the lanyard may be coupled to an item without electronics such as a pen, a pencil, a paint brush, an eating utensil, or other handheld item. When the lanyard is placed on the item, the user can use the item normally (e.g., by writing with the pen or pencil, eating with the eating utensil, and/or performing other tasks with the item), while the lanyard provides input-output capabilities by tracking the motion of the item, sensing information about the environment, providing haptic feedback, etc.

In other arrangements, the lanyard may be coupled an electronic input device. With this type of arrangement, the lanyard may enhance the existing input-output capabilities of the input device, and/or the input device may enhance the input-output capabilities of the lanyard. When the lanyard is located on the input device, the lanyard and input device may form a combined handheld input device (e.g., for a head-mounted device or other electronic device) with both the input-output capabilities of the lanyard as well as the input-output capabilities of the input device. When the lanyard is removed from the input device, the input device may be used normally (e.g., by providing input to a touch screen). This allows the user to easily switch between electronic devices using a single input device.

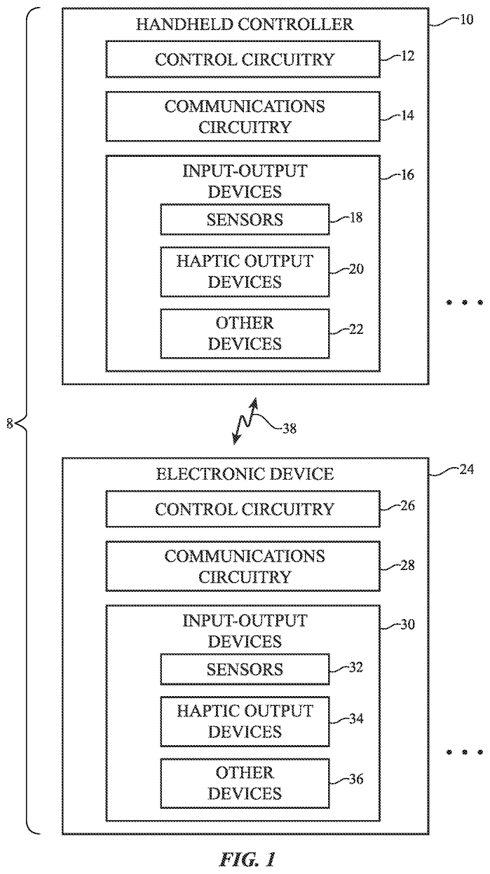

FIG. 1 is a schematic diagram of an illustrative system of the type that may include one or more input devices and/or lanyards. As shown in FIG. 1, system 8 may include electronic device(s) such as handheld input device(s) 10 and other electronic device(s) 24. Each handheld input device 10 (also referred to as input device 10 herein) may be held in the hand of a user or may be otherwise coupled to a user.

Additional electronic devices in system 8 such as devices 24 may include devices such as a laptop computer, a computer monitor containing an embedded computer, a tablet computer, a desktop computer (e.g., a display on a stand with an integrated computer processor and other computer circuitry), a cellular telephone, a media player, or other handheld or portable electronic device, a smaller device such as a wristwatch device, a pendant device, a headphone or earpiece device, a head-mounted device such as glasses, goggles, a helmet, or other equipment worn on a user's head, or other wearable or miniature device, a television, a computer display that does not contain an embedded computer, a gaming device, a remote control, a navigation device, an embedded system such as a system in which equipment is mounted in a kiosk, in an automobile, airplane, or other vehicle, a removable external case for electronic equipment, a strap, a wrist band or head band, a removable cover for a device, a case or bag that has straps or that has other structures to receive and carry electronic equipment and other items, a necklace or arm band, a wallet, sleeve, pocket, or other structure into which electronic equipment or other items may be inserted, part of a chair, sofa, or other seating (e.g., cushions or other seating structures), part of an item of clothing or other wearable item (e.g., a hat, belt, wrist band, headband, sock, glove, shirt, pants, etc.), or equipment that implements the functionality of two or more of these devices.

With one illustrative configuration, which may sometimes be described herein as an example, device 10 is a handheld input device having an elongated marker-shaped housing configured to be grasped within a user's fingers or a housing with other shapes configured to rest in a user's hand, and device(s) 24 is a head-mounted device, cellular telephone, tablet computer, laptop computer, wristwatch device, a device with a speaker, or other electronic device (e.g., a device with a display, audio components, and/or other output components). A handheld input device with a marker-shaped housing may have an elongated housing that spans across the width of a user's hand and that can be held like a pen, pencil, marker, wand, or tool.

Devices 10 and 24 may include control circuitry 12 and 26, respectively. Control circuitry 12 and 26 may include storage and processing circuitry for supporting the operation of system 8. The storage and processing circuitry may include storage such as nonvolatile memory (e.g., flash memory or other electrically-programmable-read-only memory configured to form a solid-state drive), volatile memory (e.g., static or dynamic random-access-memory), etc. Processing circuitry in control circuitry 12 and 26 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc.

To support communications between devices 10 and 24 and/or to support communications between equipment in system 8 and external electronic equipment, control circuitry 12 may communicate using communications circuitry 14 and/or control circuitry 26 may communicate using communications circuitry 28. Circuitry 14 and/or 28 may include antennas, radio-frequency transceiver circuitry, and other wireless communications circuitry and/or wired communications circuitry. Circuitry 14 and/or 28, which may sometimes be referred to as control circuitry and/or control and communications circuitry, may, for example, support bidirectional wireless communications between devices 10 and 24 over wireless link 38 (e.g., a wireless local area network link, a near-field communications link, or other suitable wired or wireless communications link (e.g., a Bluetooth® link, a WiFi® link, a 60 GHz link or other millimeter wave link, etc.). Devices 10 and 24 may also include power circuits for transmitting and/or receiving wired and/or wireless power and may include batteries. In configurations in which wireless power transfer is supported between devices 10 and 24, in-band wireless communications may be supported using inductive power transfer coils (as an example). Devices 10 and 24 may include input-output devices such as devices 16 and 30. Input-output devices 16 and/or 30 may be used in gathering user input, in gathering information on the environment surrounding the user, and/or in providing a user with output. Devices 16 may include sensors 18 and devices 30 may include sensors 32. Sensors 18 and/or 32 may include force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors (e.g., ultrasonic sensors for tracking device orientation and location and/or for detecting user input such as finger input), and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or inertial measurement units that contain some or all of these sensors), muscle activity sensors (EMG) for detecting finger actions, radio-frequency sensors, depth sensors (e.g., structured light sensors and/or depth sensors based on stereo imaging devices), optical sensors such as self-mixing interferometric sensors and light detection and ranging (lidar) sensors that gather time-of-flight measurements, optical sensors such as visual odometry sensors that gather position and/or orientation information using images gathered with digital image sensors in cameras, gaze tracking sensors, visible light and/or infrared cameras having digital image sensors, humidity sensors, moisture sensors, and/or other sensors.

In some arrangements, devices 10 and/or 24 may use sensors 18 and/or 32 and/or other input-output devices 16 and/or 30 to gather user input (e.g., buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.). If desired, device 10 and/or device 24 may include rotating buttons (e.g., a crown mechanism on a watch or other suitable rotary button that rotates and that optionally can be depressed to select items of interest). Alphanumeric keys and/or other buttons may be included in devices 16 and/or 30. In some configurations, sensors 18 may include joysticks, roller balls, optical sensors (e.g., lasers that emit light and image sensors that track motion by monitoring and analyzing changings in the speckle patterns and other information associated with surfaces illuminated with the emitted light as device 10 is moved relative to those surfaces), fingerprint sensors, and/or other sensing circuitry.

Radio-frequency tracking devices may be included in sensors 18 to detect location, orientation, and/or range. Beacons (e.g., radio-frequency beacons) may be used to emit radio-frequency signals at different locations in a user's environment (e.g., at one or more registered locations in a user's home or office). Radio-frequency beacon signals can be analyzed by devices 10 and/or 24 to help determine the location and position of devices 10 and/or 24 relative to the beacons. If desired, devices 10 and/or 24 may include beacons. Frequency strength (received signal strength information), beacon orientation, time-of-flight information, and/or other radio-frequency information may be used in determining orientation and position information. At some frequencies (e.g., lower frequencies such as frequencies below 10 GHZ), signal strength information may be used, whereas at other frequencies (e.g., higher frequencies such as frequencies above 10 GHZ), indoor radar schemes may be used). If desired, light-based beacons, ultrasonic beacons, and/or other beacon devices may be used in system 8 in addition to or instead of using radio-frequency beacons and/or radio-frequency radar technology.

Devices 16 and/or 30 may include haptic output devices 20 and/or 34. Haptic output devices 20 and/or 34 can produce motion that is sensed by the user (e.g., through the user's fingertips). Haptic output devices 20 and/or 34 may include actuators such as electromagnetic actuators, motors, piezoelectric actuators, electroactive polymer actuators, vibrators, linear actuators (e.g., linear resonant actuators), rotational actuators, actuators that bend bendable members, actuator devices that create and/or control repulsive and/or attractive forces between devices 10 and/or 24 (e.g., components for creating electrostatic repulsion and/or attraction such as electrodes, components for producing ultrasonic output such as ultrasonic transducers, components for producing magnetic interactions such as electromagnets for producing direct-current and/or alternating-current magnetic fields, permanent magnets, magnetic materials such as iron or ferrite, and/or other circuitry for producing repulsive and/or attractive forces between devices 10 and/or 24). In some situations, actuators for creating forces in device 10 may be used in applying a sensation on a user's fingers (e.g., a sensation of weight, texture, pulling, pushing, torque, etc.) and/or otherwise directly interacting with a user's fingers. In other situations, these components may be used to interact with each other (e.g., by creating a dynamically adjustable electromagnetic repulsion and/or attraction force between a pair of devices 10 and/or between device(s) 10 and device(s) 24 using electromagnets).

If desired, input-output devices 16 and/or 30 may include other devices 22 and/or 36 such as displays (e.g., in device 24 to display images for a user), status indicator lights (e.g., a light-emitting diode in device 10 and/or 24 that serves as a power indicator, and other light-based output devices), speakers and other audio output devices, electromagnets, permanent magnets, structures formed from magnetic material (e.g., iron bars or other ferromagnetic members that are attracted to magnets such as electromagnets and/or permanent magnets), batteries, etc. Devices 10 and/or 24 may also include power transmitting and/or receiving circuits configured to transmit and/or receive wired and/or wireless power signals.

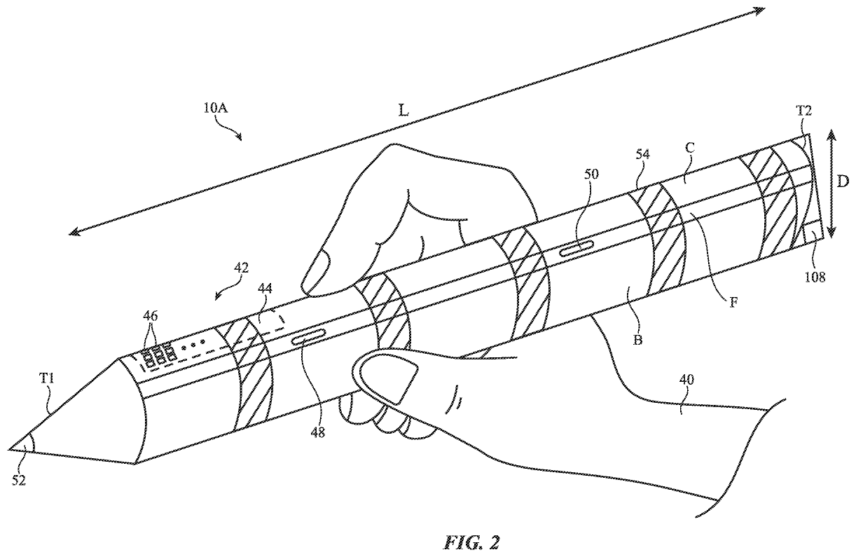

FIG. 2 is a perspective view of a user's hand (hand 40) and an illustrative handheld input device 10 (sometimes referred to as a handheld controller). As shown in FIG. 2, input device 10 may be an elongated marker-shaped electronic device that fits within the user's hand 40. The elongated shape of input device 10 allows hand 40 to hold input device 10 as if it were a pen, pencil, marker, or other writing implement. In other configurations, input device 10 may be held in hand 40 as a wand or baton would be held. In general, input device 10 may be held in hand 40 in any suitable manner (e.g., at the end, in the middle, between two, three, four, or all five fingers, with both hands, etc.).

A user may hold one or more of devices 10 simultaneously. For example, a user may hold a single one of devices 10 in the user's left or right hand. As another example, a user may hold a first device 10 in the user's left hand and a second device 10 in the user's right hand. Arrangements in which multiple devices 10 are held in one hand may also be used.

Configurations in which devices 10 have bodies that are held within a user's hands are sometimes described herein as an example.

Control circuitry 12 of FIG. 1 (and, if desired, communications circuitry 14 and/or input-output devices 16) may be contained entirely within device 10 (e.g., in housing 54) and/or may include circuitry that is located in an external structure (e.g., in an external electronic device such as device 24, a console, a storage case, etc.).

In general, electrical components such as control circuitry 12, communications circuitry 14, and/or input-output devices 16 (e.g., sensors 18, haptic output devices 20, and/or other devices 22) may be mounted within and/or on the surface(s) of input device housing 54 in any suitable locations.

As shown in FIG. 2, housing 54 may have an elongated marker shape, elongated tube shape, elongated cylindrical shape, and/or any other elongated shape. Housing 54 which may sometimes be referred to as an enclosure, body, or case, may be formed of plastic, glass, ceramics, fiber composites, metal (e.g., stainless steel, aluminum, etc.), fabric, other suitable materials, or a combination of any two or more of these materials. Housing 54 may be formed using a unibody configuration in which some or all of housing 54 is machined or molded as a single structure or may be formed using multiple structures (e.g., an internal frame structure, one or more structures that form exterior housing surfaces, etc.). Housing 54 may form outer housing walls, tip portions, and/or internal support structures for device 10. Housing 54 may have a length L between 140 mm and 150 mm, between 130 mm and 160 mm, between 100 mm and 200 mm, between 120 mm and 160 mm, greater than 180 mm, less than 180 mm, or any other suitable length. The diameter D of housing 54 may be between 12 mm and 14 mm, between 10 mm and 15 mm, between 11 mm and 16 mm, between 15 mm and 20 mm, between 18 mm and 25 mm, greater than 25 mm, less than 25 mm, or any other suitable diameter.

Housing 54 may have one or more curved surfaces and one or more planar surfaces. In the illustrative example of FIG. 2, device 10 has a curved surface C that wraps around a first portion of device 10 and a flat surface F that extends along a second portion of device 10. If desired, flat surface F may be located on a first side of device 10 and curved surface C may be located on a second opposing side of device 10. Curved surface C and flat surface F wrap around device 10 to form an elongated tube shape that surrounds an elongated interior space for housing internal components such as control circuitry 12, communications circuitry 14, and input-output devices 16. Housing 54 may have an elongated shaft portion such as shaft B extending between first and second tip portions such as tip portion T1 at a first end of device 10 and tip portion T2 at a second opposing end of device 10. One or both of housing tip portions T1 and T2 may be removable from the main elongated shaft B between tip portions T1 and T2.

Ultrasonic sensors, optical sensors, inertial measurement units, touch sensors such as capacitive touch sensor electrodes, strain gauges and other force sensors, radio-frequency sensors, and/or other sensors may be used in gathering sensor measurements indicative of the activities of device 10 and/or hand 40 holding device 10.

In some configurations, input device position, movement, and orientation may be monitored using sensors that are mounted in external electronic equipment (e.g., in a computer or other desktop device, in a head-mounted device or other wearable device, and/or in other electronic device 24 that is separate from device 10). For example, optical sensors such as images sensors that are separate from device 10 may be used in monitoring device 10 to determine the position, movement, and/or orientation of device 10. If desired, devices 10 may include passive and/or active optical registration features to assist an image sensor in device 24 in tracking the position, orientation, and/or motion of device 10. For example, devices 10 may include light-emitting devices. The light-emitting devices may include light-emitting diodes, lasers (e.g., laser diodes, vertical cavity surface-emitting lasers, etc.), or other light sources and may operate at visible wavelengths, ultraviolet wavelengths, and/or infrared wavelengths. The light-emitting devices may be arranged in an asymmetric pattern (or other suitable pattern) on housing 44 and may emit light that is detected by an image sensor, depth sensor, and/or other light-based tracking sensor circuitry in device 24 (e.g., a head-mounted device, desktop computer, stand-alone camera-based monitoring systems, and/or other electrical equipment with an image sensor or other tracking sensor circuitry). By processing the received patterned of emitted light, such as by using an image recognition algorithm, device 24 can determine the position, orientation, and/or motion of device 10. If desired, the light-emitting devices can be removable and/or customizable (e.g., a user can customize the location and type of light-emitting devices).

Tracking can also be performed that involves extrapolating from a known body part orientation (e.g., a finger orientation) to produce orientation information on other body parts (e.g., wrist and/or arm orientation estimated using inverse kinematics). Visual odometry sensors, such as visual-inertial odometry (VIO) cameras, may, if desired, be included in devices 10. These sensors may include image sensors that gather frames of image data of the surroundings of devices 10 and may be used in measuring position, orientation, and/or motion from the frame of image data. Lidar, ultrasonic sensors oriented in multiple directions, radio-frequency tracking sensors, and/or other input device tracking arrangements may be used, if desired.

In some arrangements, user input for controlling system 8 can include both user input to input device 10 and other user input (e.g., user eye gaze input, user voice input, etc.). For example, gaze tracking information such as a user's point-of-gaze measured with a gaze tracker can be fused with input to input device 10 when controlling device 10 and/or devices 24 in system 8. A user may, for example, gaze at an object of interest while device 10 uses one or more of sensors 18 (e.g., an accelerometer, force sensor, touch sensor, etc.) to gather information such as tap input (tap input in which a user taps on device 10 with one or more fingers, tap input in which device 10 taps a table top or other external surface or object, and/or any other tap input resulting in measurable forces and/or accelerometer output from device 10), double-tap input, force input, input device gestures (tapping, swiping, twirling, shaking, writing, drawing, painting, sculpting, gaming, and/or other gestures with device 10, gestures on external surfaces with device 10, gestures on external objects with device 10, gestures interacting with virtual objects, gestures with input device 10 in the air, etc.), drag and drop operations associated with objects selected using a lingering gaze or other point-of-gaze input, etc. The input from input device 10 to system 8 may include information on finger orientation, position, and/or motion relative to input device 10, may include information on how forcefully a finger is pressing against surfaces of input device 10 (e.g., force information), may include information on how forcefully input device 10 is pressed against an object or external surface (e.g., how forcefully a tip portion such as tip portion T1 presses against an external surface), may include pointing input (e.g., the direction in which input device 10 is pointing), which may be gathered using radio-frequency sensors among sensors 18 and/or other sensors in device(s) 10, and/or may include other input.

By correlating user input from a first of devices 10 with user input from a second of devices 10 and/or by otherwise analyzing sensor input, multi-device input may be detected and used in manipulating virtual objects or taking other actions in system 8. Consider, as an example, the use of a tap gesture with device 10 to select a virtual object associated with a user's current point-of-gaze. Once the virtual object has been selected based on the direction of the user's point-of-gaze (or pointing direction input) and based on the tap gesture input or other user input, further user input gathered with one or more devices 10 may be used to rotate and/or otherwise manipulate the virtual object. For example, information on input device movement (e.g., rotational movement) may be gathered using an internal measurement unit or other sensor 18 in device(s) 10 and this rotational input may be used to rotate the selected object. In some scenarios, an object may be selected based on point-of-gaze (e.g., when a user's point-of-gaze is detected as being directed toward the object) and, following selection, object attributes (e.g., virtual object attributes such as virtual object appearance and/or real-world object attributes such as the operating settings of a real-world device) can be adjusted using strain gauge input, touch sensor input, input device orientation input (e.g., to rotate a virtual object, etc.).

If desired, gestures such as air gestures (three-dimensional gestures) with device 10 may involve additional input. For example, a user may control system 8 using hybrid gestures that involve movement of device(s) 10 through the air (e.g., an air gesture component) and that also involve contact between device 10 and one or more fingers of hand 40. As an example, an inertial measurement unit in device 10 and/or a camera in device 24 may detect user movement of device 10 through the air (e.g., to trace out a path) while a sensor 18 in device 10 such as a two-dimensional touch sensor, a force sensor, or other sensor 18 detects force input, touch input, or other input associated with contact to device 10.

The sensors in device 10 may, for example, measure how forcefully a user is moving device 10 against a surface (e.g., in a direction perpendicular to the surface) and/or how forcefully a user is moving device 10 along a surface (e.g., shear force in a direction parallel to the surface). The direction of movement of device 10 can also be measured by the force sensors and/or other sensors 18 in device 10.

Information gathered using sensors 18 such as force sensor input gathered with a force sensor, motion data gathered with a motion sensor (e.g., pointing input, rotations, etc.), location information indicating the location of input device 10, touch input gathered with a touch sensor, and other user input may be used to control external equipment such as device 24. For example, control circuitry 12 may send control signals to device 24 that include instructions to select a user interface element, instructions to scroll display content, instructions to select a different input function for input device 10 (e.g., to switch from using input device 10 as a drawing or writing implement to using input device 10 as a pointing device or game piece), instructions to draw a line or type a word on a display in device 24, instructions to adjust operational settings of device 24, instructions to manipulate display content on device 24, and/or instructions to take any other suitable action with device 24. These control signals may be sent in addition to or instead of providing feedback to sensor input from device 10 (e.g., haptic output, audio output, adjusting operational settings of device 10, etc.).

In the illustrative configuration of FIG. 2, device 10 includes touch sensor 42. Touch sensor 42 may be formed from an array of capacitive touch sensor electrodes such as electrodes 46 overlapping one or more surfaces of housing 54 such as curved surface C, flat surface F. and/or surfaces on tip portions T1 and T2. Touch sensor 42 may be configured to detect swipes, taps, multitouch input, squeeze input, and/or other touch input. In some arrangements, touch sensor 42 is formed from a one-dimensional or two-dimensional array of capacitive electrodes 46. In some arrangements, touch sensor 42 may be a strain gauge that detects squeeze input to housing 54 (e.g., when a user squeezes or pinches device 10 between the user's fingers). Touch sensor 42 may be used to gather touch input such as input from direct contact and/or close proximity with a different finger of the user or other external object. In the example of FIG. 2, touch sensor 42 overlaps touch input area 44 on curved surface C of device 10. If desired, additional touch input may be gathered in adjacent areas such as flat surface F of housing 54. If desired, touch sensor 42 may include other types of touch sensing technologies such as optical touch sensors, acoustic-based touch sensors, etc. Touch sensor 42 may span the length L of device 10, may span only partially along length L of device 10, may cover some or all of curved surface C, may cover some or all of flat surface F, and/or may cover some or all of tip portions T1 and T2. If desired, touch sensor 42 may be illuminated, may overlap a display (e.g., to form a touch-sensitive display region on device 10), may overlap an indicator or textured surface, and/or may otherwise be visually or tangibly distinct from the surrounding non-touch-sensitive portions of housing 54 (if desired).

In addition to or instead of touch sensor 42, device 10 may include one or more other user input devices such as user input device 48. User input device 48 may be a mechanical input device such as a pressable button, a rotating knob, a rotating wheel, a rocker switch, a slider, or other mechanical input device, a force sensor such as a strain gauge or other force sensor, an optical sensor such as a proximity sensor, a touch sensor such as a capacitive, acoustic, or optical touch sensor, and/or any other suitable input device for receiving input from a user's hand 40. If desired, one of haptic output devices 20 such as an actuator may be used to provide haptic feedback in response to user input to device 48. For example, input device 48 may be a touch-sensitive button that does not physically move relative to housing 54, but the user may feel a localized button click sensation from haptic output that is provided from an actuator 20 overlapping device 48.

In addition to or instead of touch sensor 42 and input device 48, device 10 may include one or more sensors at tip portions T1 and T2. For example, tip portion T1 and/or tip portion T2 may be force-sensitive. As shown in FIG. 2, device 10 may include sensor 52. Sensor 52 may be located at one or both of tip portions T1 and T2 and/or may be located elsewhere in device 10 such as at a location along shaft B of device 10. Shaft B, which may sometimes be referred to as a cylindrical housing, may form an elongated main body portion of housing 54 of device 10 that extends between tip T1 and tip T2. One or more of tip portions T1 and T2 may be removable and may sometimes be referred to as a cap, a writing tip, etc. Sensors at tip portions T1 and T2 such as sensor 52 may include a device position sensor (e.g., an optical flow sensor having a light source that illuminates a portion of a surface that is contacted by device 10 and having an image sensor configured to determine a location of device 10 on the surface and/or to measure movement of the electronic device relative to the surface based on captured images of the illuminated portion, a mechanical position sensor such as an encoded wheel that tracks movements of device 10 on the surface, or other device position sensor), a force sensor (e.g., one or more strain gauges, piezoelectric force sensors, capacitive force sensors, and/or any other suitable force sensor), an optical proximity sensor such a light-emitting diode and light detector, a camera (e.g., a one-pixel camera or an in image sensor with a two-dimensional array of pixels), and/or other sensor.

Device 10 may circuitry for receiving wired and/or wireless power. For example, wired power may be conveyed to device 10 through a charging port such as charging port 108, and wireless power may be conveyed to device 10 through capacitively coupled contacts and/or a inductive charging coil such as coil 50. If desired, device 10 may only receive wired power and coil 50 may be omitted. In other arrangements, device 10 may only receive wireless power and charging port 108 may be omitted (or port 108 may serve as a data port, audio port, or other suitable port). In arrangements where device 10 includes circuitry for receiving wireless power, power can be conveyed wirelessly between device 10 and an external electronic device such as device 24 (e.g., a head-mounted device, a wireless charging mat, a storage case, a battery case, a wireless charging puck, or other electronic device). As an example, contacts (e.g., metal pads) may be capacitively coupled (without forming ohmic contact) to allow power to be transferred and/or power can be conveyed using a wireless power transmitter with a coil in device 24 to transmit wireless power signals to a wireless power receiver with a coil in device 10. Inductive power transfer techniques may be used (e.g., wireless power can be transmitted using one or more wireless power transmitting coils in device 24 and transmitted wireless power signals can be received in a power receiving circuit in device 10 using a power receiving coil such as coil 50). Received alternating-current wireless power signals from device 24 can be converted to direct-current power using a rectifier in device 10 for charging a battery in device 10 and/or for powering circuitry in device 10. In configurations in which the power receiving circuit of device 10 receives power via a wired connection (e.g., using terminals), the power receiving circuit in device 10 may provide the received power to a battery and/or other circuitry in device 10.

To help align wireless charging coil 50 in device 10 with a wireless charging coil in device 24 and/or to otherwise hold device 10 to a power source or other device (e.g., device 24 of FIG. 1), device 10 and device 24 may be provided with mating alignment features (e.g., mating protrusions and recesses and/or other interlocking alignment structures (e.g., key and keyhole structures that allow device 10 and/or device 24 to interlock when engaged by twisting or other locking motions), magnets (or ferromagnetic elements such as iron bars), and/or other alignment structures.

In configurations in which device 10 includes magnetic attachment structures (e.g., magnets, magnetic material that is attracted to magnets, or other magnetic attachment structures), device 10 may be held against the interior and/or exterior of device 24 using the magnetic attachment structures. For example, device 24 may be a battery case with a groove or other recess that receives device 10. Magnetic attachment structures in device 24 (e.g., near the groove) and in device 10 may corporate (magnetically attached) to help secure device 10 within the interior of the case (e.g., without allowing device 10 to rattle excessively inside the case). As another example, device 24 may be a head-mounted device (e.g., goggles and/or glasses) or a strap or other wearable device. In this type of arrangement, magnetic attachment structures may hold device 10 against an exterior surface of device 24 (e.g., against a portion of the housing of a pair of goggles or glasses such as along the frame of a pair of glasses, to the front, top, or side surface of a pair of goggles, etc.) or within a recess in the housing of device 24. Magnets and other alignment features may be located near coil 50 or may be located in other portions of housing 54.

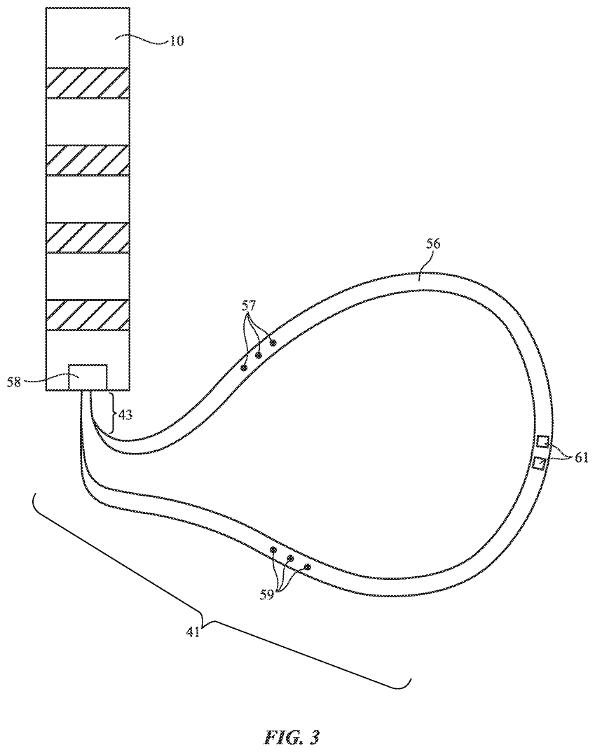

In some arrangements, handheld input device 10 may be a stand-alone input device with all of the input-output components of input device 10 formed in a common housing. In other arrangements, the input-output capabilities of handheld input device 10 may be shared with a removable object, such as a lanyard. For example, the lanyard may include light-emitting devices (such as infrared light-emitters) that allow the lanyard position to be tracked by a camera or other sensor in a head-mounted device. Alternatively, a lanyard itself may be a smart device, such as includes sensors (e.g., cameras), output devices (e.g., haptic output devices), light sources, a battery, charging circuitry, and/or other components. If the lanyard itself can communicate with the head-mounted device, then the lanyard may be coupled to any suitable object, such as a stylus, rod, bat, utensil, pen, pencil, or other object, and the object with the attached lanyard may be used as an input device. An illustrative example of a lanyard coupled to an input device is shown in FIG. 3.

As shown in FIG. 3, lanyard 56 may be coupled to input device 10 at connector 58. Lanyard 56 may be, for example, a fabric lanyard or a polymer lanyard. For example, lanyard 56 may be formed from a knit fabric, a woven fabric, strips of polymer, segmented polymer portions and/or other suitable materials. In some embodiments, lanyard 56 may include main portion 41, that is formed from fabric, polymer or other material and may include end portion 43 that connects/attaches to connector 58.

Lanyard 56 may have a cylindrical cross-sectional profile. For example, lanyard 56 may be braided to form a tube-like structure. In other words, lanyard 56 may be similar to a cord. Various components, such as light emitters, sensors (e.g., optical sensors or motion sensors), or output devices, may be mounted on the surface of lanyard 56 or may be formed in cavities in lanyard 56. Alternatively, lanyard 56 may be flat (e.g., may be a flat knit lanyard), and components may be mounted to one of the flat surfaces of lanyard 56. In some embodiments, lanyard 56 may have portions with flat cross-sections (e.g., flat knit sections) and portions with cylindrical cross sections (e.g., braided sections), and the components of lanyard 56 may be mounted on the portions with flat cross-sections. In general, however, lanyard 56 may have any suitable shape(s).

Connector 58 may be, as an example, a hook or bar through which a string at the end of lanyard 56 may be wrapped. Alternatively, connector 58 may be a magnetic connector (e.g., the end of device 10 may have a first magnetic polarity, and the end of lanyard 56 may have a second magnetic polarity that is attracted to the end of device 10), a USB connector (e.g., a USB-C connector), a lightning port connector, an auxiliary jack connector (e.g., a headphone jack connector), or any other suitable connector. For example, connector 56 may be correspond to charging portion 108 of FIG. 2. In some embodiments, power and/or data may be transferred between input device 10 and lanyard 56 over connector 58. For example, input device 10 may have a battery, and power may be transferred to components in lanyard 56 over connector 58. However, this arrangement is merely illustrative. Lanyard 56 may have its own power source, and/or data and/or power may be transferred from lanyard 56 to input device 10, if desired.

Lanyard 56 may include light emitters, such as light-emitting diodes (LEDs) 57. LEDs 57 may be, for example, infrared LEDs. In other words, LEDs 57 may output infrared light, such as light at 940 nm or other suitable infrared wavelength(s). An optical sensor in a head-mounted device to which lanyard 56 is providing input may track LEDs 57. In particular, because LEDs 57 are arranged along lanyard 56, an optical sensor, such as a camera, in the associated head-mounted device (or other electronic device) may image or otherwise measure the output of LEDs 57. Using image recognition, input device 10 and/or the associated head-mounted device may determine the position and/or orientation of lanyard 57 based on the positions of LEDs 57 in the captured image(s). The positions of LEDs 57 may be tracked over subsequent frames to determine the movement of lanyard 56. In this way, LEDs 57 may be used to track the location, orientation, and/or motion of lanyard 56, which may be used as an input to the associated head-mounted device (or other electronic device).

LEDs 57 may be coupled to a surface of lanyard 56 or may be formed in cavities in lanyard 56, such as by attaching LEDs 57 to lanyard 56 using an adhesive. Alternatively, LEDs 57 may be woven or knit into lanyard 56. For example, conductive strands, such as copper (as well as insulating fabric, if desired), and LED packages may be woven or knit into lanyard 56, thereby forming LEDs 57 integrally with lanyard 56. However, this is merely illustrative. In general, LEDs 57 may be attached to lanyard 56 in any suitable manner.

Although LEDs 57 are shown on only a portion of lanyard 56, LEDs 57 may extend entirely around lanyard 56, or may extend around any suitable portion of lanyard 56 so that lanyard 56 may be tracked by the associated head-mounted device. Additionally, LEDs 57 may be formed in any desired pattern on lanyard 56.

Alternatively or additionally, lanyard 56 may include fiducials 59. Fiducials 59 may be formed from retroreflective material, photoluminescent material, or other suitable material. In some embodiments, fiducials 59 may reflect infrared light that is emitted by an associated head-mounted device, and the head-mounted device may determine the position and/or orientation of fiducials 59 (and therefore of lanyard 56) by sensing the reflected infrared light with an infrared camera or other sensor. The positions of fiducials 59 may be tracked over time (e.g., over subsequent sampling frames) to determine the movement of lanyard 56. In this way, fiducials 59 may be used to track the location, orientation, and/or motion of lanyard 56, which may be used as an input to the associated head-mounted device (or other electronic device).

Fiducials 59 may be coupled to a surface of lanyard 56 or may be formed in cavities in lanyard 56, such as by attaching fiducials 59 to lanyard 56 using an adhesive. In some embodiments, fiducials 59 may be painted onto lanyard 56, such as by painting lanyard 56 with a high-contrast paint. Alternatively, fiducials 59 may be heat pressed onto lanyard 56, such as heat pressing high-contrast material (e.g., high-contrast polymer) onto lanyard 59. In other embodiments, fiducials 59 may be formed by ablating (e.g., laser ablating) outer layers (e.g., outer strands) of lanyard 56 to reveal a high-contrast material underneath.

In some illustrative embodiments, fiducials 59 may be woven or knit into lanyard 56. For example, retroreflective material, photoluminescent material, and/or other suitable fiducial material may be knit or woven into lanyard 59 (e.g., as strands). In this way, fiducials 59 may be formed integrally with lanyard 56. However, this is merely illustrative. In general, fiducials 59 may be attached to lanyard 56 in any suitable manner.

Although fiducials 59 are shown on only a portion of lanyard 56, fiducials 59 may extend entirely around lanyard 56, or may extend around any suitable portion of lanyard 56 so that lanyard 56 may be tracked by the associated head-mounted device. Additionally, fiducials 59 may be formed in any desired pattern on lanyard 56.

Although not show in FIG. 3, lanyard 56 may be formed from a high contrast material. For example, lanyard 56 may be formed from a fabric or polymer that has a bright color, such as an orange, yellow, or red color. Alternatively, lanyard 56 may include material that provides a high contrast at infrared wavelengths. The high-contrast material may be attached to the fabric or other material of lanyard 56 through heat pressing or adhesive, or high-contrast strands may be woven or knit into lanyard 56. In this way, lanyard 56 may be tracked by an associated head-mounted device.

Instead of, or in addition to, LEDs 57 and/or fiducials 59, lanyard 56 may include input-output components 61. For example, components 61 may include a motion sensor, such as an inertial measurement unit (IMU), an accelerometer, a gyroscope, or other suitable motion sensor. Alternatively or additionally, components 61 may include one or more cameras, strain gauges, haptic output components, or other input-output components (e.g., sensors). In an illustrative embodiment, components 61 on lanyard 56 may include one or more visual-inertial odometry (VIO) cameras. The VIO camera(s) may include cameras in different directions. Images taken by the VIO camera(s) may be compared to determine a location, orientation, and/or motion of lanyard 56. If desired, an IMU in components 61 may provide additional information regarding the location, orientation, and/or motion of lanyard 56. Information regarding the location, orientation, and/or motion of lanyard 56 may be communicated to the associated head-mounted device over a wired or wireless communication link, if desired.

In another illustrative embodiment, components 61 may include touch sensors, such as capacitive touch sensors and/or touch sensors formed from infrared LEDs and associated photodiodes. In particular, the touch sensors may determine whether a portion of lanyard 56 has been touched, either by a body part of a user (e.g., a wrist) to determine that lanyard 56 is being word, or by a finger to determine an input (e.g., a tap or swipe input to provide input to the associated head-mounted device). The output of the touch sensor(s) may provide input to the associated head-mounted device (or other electronic device).

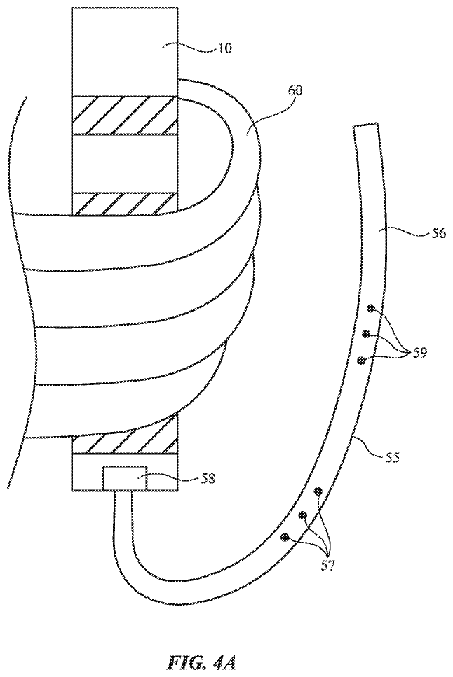

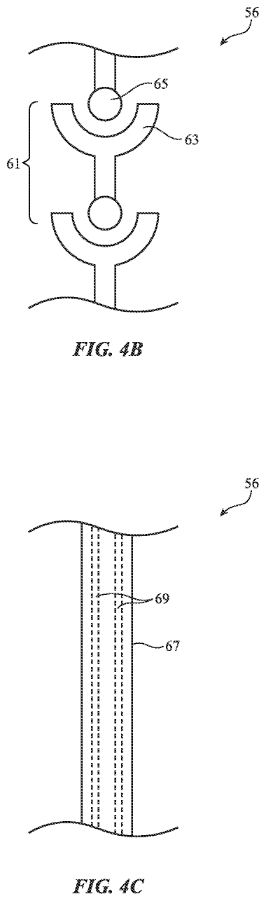

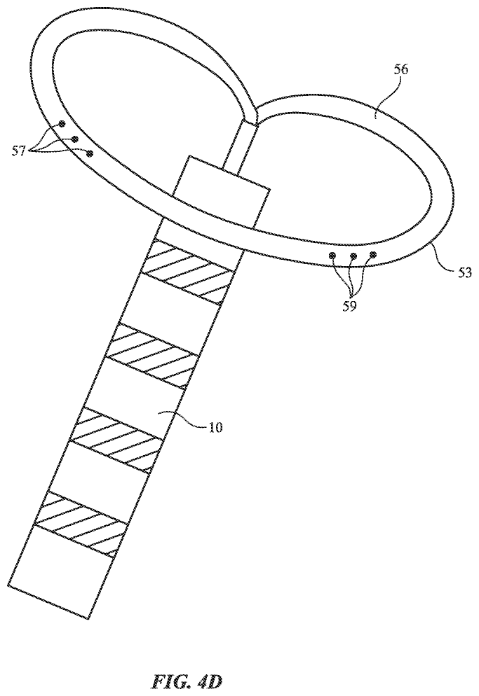

Regardless of the light emitters, fiducials, and/or input-output components on lanyard 56, it may be desirable to place lanyard 56 into different orientations to track the position of lanyard 56 (and the associated input device 10 or another object to which lanyard 56 is attached). An illustrative example of placing a lanyard into a desired position is shown in FIG. 4A.

As shown in FIG. 4A, lanyard 56 may be coupled to input device 10 at connector 58. When input device 10 is held by hand 60, parts of the input device 10 may be overlapped or otherwise obscured by hand 60. Alternatively, it may be desirable to provide additional input than what may be provided by device 10, or lanyard 56 may be coupled to a non-electronic object, such as a pencil or pen.

Regardless of the object to which lanyard 56 is attached, lanyard 56 may be curved with curvature 55. As shown in FIG. 4A, when curved with curvature 55, lanyard 56 may overlap the fingers of hand 60. If desired, curvature 55 may have a similar curvature to the fingers of hand 60 when gripping device 10. However, this is merely illustrative. In general, lanyard 56 may have any desired curvature.

By curving lanyard 56 around hand 60, light emitters 57, fiducials 59, and/or the material of lanyard 56 (e.g., high-contrast material) may be visible to a camera or other sensor on an associated head-mounted device. In other words, the head-mounted device may track the position of lanyard 56 by taking images or otherwise sensing the position of light emitters 57, fiducials 59, and/or the material of lanyard 56. Therefore, when a user moves hand 60, the head-mounted device may be able to determine the amount of hand movement and/or change in orientation. In this way, the user's movement of hand 60 (and therefore of device 10 and lanyard 56) may be sensed by the head-mounted device using the markings and/or components of lanyard 56, and the movement may be used as an input to the associated head-mounted device (or other electronic device).

Lanyard 56 may be curved with curvature 55 in any suitable manner. In an illustrative example, a lanyard, such as lanyard 56 may be formed from friction fit joints. As shown in FIG. 4B, lanyard 56 may be formed from links 61. Links 61 may be formed from polymer, metal, or other suitable material. Friction fit joints may be formed between links 61 as illustrated by friction fit joint portions 63 and 65. In particular, portion 65 may fit snugly into portion 63 (e.g., within less than 1 mm or other suitable size difference), so that portion 65 may move relative to portion 63 when pressure is enough applied to portion 65, but will remain in place relative to portion 63 due to friction when desired. By forming lanyard 56 from links 61 of friction fit joints, lanyard 56 may be curved or otherwise moved into any desired shape. For example, lanyard 56 may be adjusted to have curvature 55 of FIG. 4A, or may be adjusted to have another suitable shape using the friction fit joints between links 61.

As an alternative to forming lanyard 56 from links of friction fit joints, a lanyard, such as lanyard 56, may be formed from fabric with stiffeners. In the illustrative example of FIG. 4C, lanyard 56 may include fabric 67 and stiffeners 69. Fabric 67 may be, as examples, knit fabric, woven fabric, webbing, or other suitable fabric. Stiffeners 69 may be formed from a stiffer material than fabric 67, such as polymer, metal, a braided cord, or other suitable material. In the example of FIG. 4C, stiffeners 69 may be embedded within fabric 67 (e.g., formed between two or more layers of fabric 67, formed in a webbing of fabric 67, or otherwise embedded in fabric 67). However, this is merely illustrative. If desired, stiffeners 69 may be formed on a surface of fabric 67, such as with adhesive or by heat pressing, or stiffeners 69 may be formed integrally with fabric 67, such as by weaving or knitting rigid material with the fabric portions of fabric 67.

Regardless of the way in which stiffeners 69 are incorporated into lanyard 56, stiffeners 69 may allow lanyard 56 may be curved or otherwise moved into any desired shape. In other words, stiffeners 69 may be flexible enough to allow stiffeners 69 to be curved or otherwise adjusted into a desired shape, yet rigid enough to maintain their shape after adjustment. For example, lanyard 56 may be adjusted to have curvature 55 of FIG. 4A, or may be adjusted to have another suitable shape using stiffeners 69.

The examples of FIGS. 4B and 4C are merely illustrative of stiffening structures and/or materials that may allow lanyard 56 to be adjusted into a desired shape and therefore maintain its shape, such as the curvature of FIG. 4A. Another illustrative example of a shape in which lanyard 56 may be adjusted is shown in FIG. 4D.

As shown in FIG. 4D, lanyard 56 may be adjusted into loop 53. Stiffening structures or materials, such as the friction fit hinges of FIG. 4B and/or the stiffeners of FIG. 4B, may maintain the shape of lanyard 56 in loop 53.

By adjusting lanyard 56 into loop 53, loop 53 may be over a user's hand when holding device 10 (or other object), and light emitters 57, fiducials 59, and/or the material of lanyard 56 (e.g., high-contrast material) may be visible to a camera or other sensor on an associated head-mounted device. In other words, the head-mounted device may track the position of lanyard 56 by taking images or otherwise sensing the position of light emitters 57, fiducials 59, and/or the material of lanyard 56. Therefore, when a user moves their hand, the head-mounted device may be able to determine the amount of hand movement and/or change in orientation. In this way, the user's movement of their hand (and therefore of device 10 and lanyard 56) may be sensed by the head-mounted device using the markings and/or components of lanyard 56.

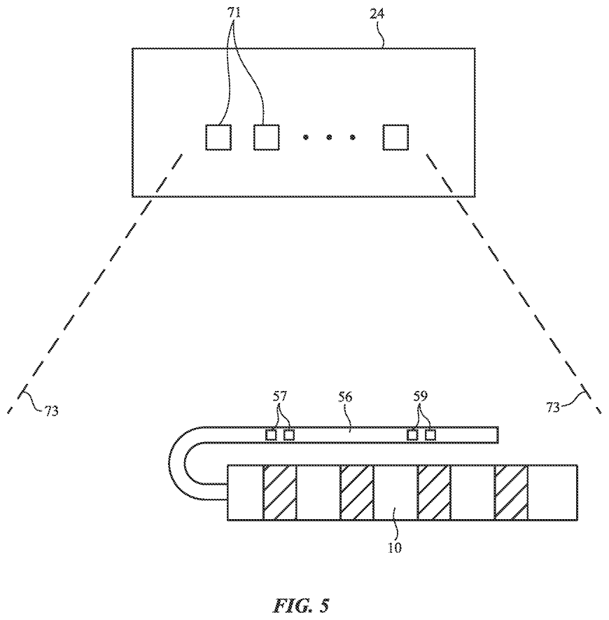

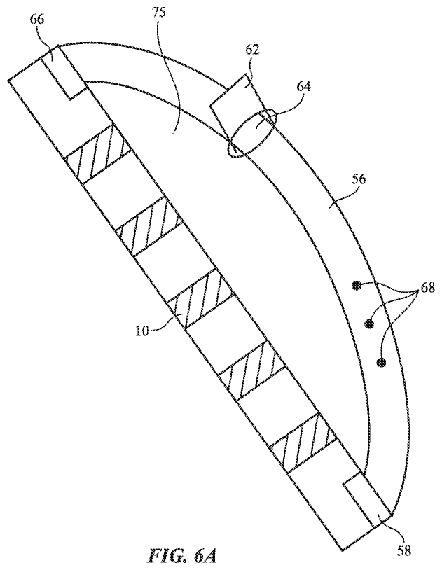

The illustrative shapes of lanyard 56 in FIGS. 4A and 4D are merely illustrative. In general, lanyard 56 may be adjusted into any suitable shape to allow lanyard 56 to be tracked by an associated head-mounted device (or other electronic device). An illustrative example of a head-mounted device tracking a lanyard is shown in FIG. 5.

As shown in FIG. 5, lanyard 56 may be attached to device 10 and may be curved with a similar curvature to curvature 55 of FIG. 4A. In general, however, lanyard 56 may be attached to any desired electronic device or non-electronic object, and lanyard 56 may have any suitable shape and/or orientation.

Lanyard 56 may include light emitter 57, fiducials 59, and/or high-contrast material (such as high-contrast fabric, polymer, or other material). Head-mounted device 24 may include one or more sensors 71. Sensors 71 may include one or more cameras (e.g., an infrared camera), or other desired optical device.

Sensors 71 may have a field-of-view defined by lines 73, which may be a field-of-view of at least 50°, at least 60°, or another suitable angle. Lanyard 56 may be within the field-of-view of sensors 71. Therefore, sensors 71 may take images of lanyard 56 that include light emitters 57, fiducials 59, and/or high-contrast material of lanyard 56. Using image recognition, circuitry in head-mounted device 24, such as control circuitry 26 of FIG. 1, may determine the locations of light emitters 57, fiducials 59, and/or high-contrast material of lanyard 56. In some embodiments, subsequent images may be used to track the locations and/or orientations of light emitters 57, fiducials 59, and/or high-contrast material of lanyard 56 over time to determine the motion of light emitters 57, fiducials 59, and/or high-contrast material of lanyard 56. Based on the determined locations, orientations, and/or movements of light emitters 57, fiducials 59, and/or high-contrast material of lanyard 56, head-mounted device 24 may determine a location, orientation, and/or movement of lanyard 56. The location, orientation, and/or movement of lanyard 56 may then be used as an input to head-mounted device 24.

For example, the location, orientation, and/or movement of lanyard 56 may be used to interact with virtual objects displayed by head-mounted device 24, may be used to adjust a setting of head-mounted device 24, may be used as a video game controller for a video game displayed by head-mounted device 24, or may otherwise by used as an input to device 24.

Although device 24 has been described as a head-mounted device, this is merely illustrative. In general, device 24 may be any suitable device, such as a computer, a cellular telephone, a tablet, or other device.

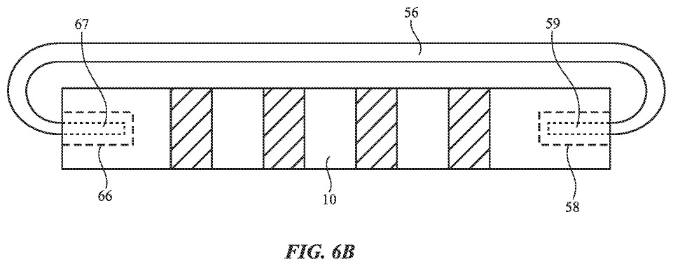

In some embodiments, it may be desirable for a lanyard, such as lanyard 56, to attach to a device or object, such as input device 10, at two locations to allow for the lanyard to be stowed when not in use and/or to be used for more compact tracking. An illustrative example is shown in FIG. 6A.

As shown in FIG. 6A, lanyard 56 may be coupled to input device 10 using connector 58 and connector 66. Connectors 58 and 66 may be end portions (e.g., end portion 43 of FIG. 3) of lanyard 56 that extend past or are coupled to the main portion of lanyard 56 (e.g., main portion 41 of FIG. 3). Connectors 58 and 66 may be any suitable connectors. As examples, connectors 58 and 66 may be hooks or bars through which strings at the ends of lanyard 56 may be wrapped, may be magnetic connectors (e.g., the ends of device 10 may have first magnetic polarities, and the ends of lanyard 56 may have second magnetic polarities that are attracted to the end of device 10), USB connectors (e.g., USB-C connectors), lightning port connectors, auxiliary jack connectors (e.g., headphone jack connectors), or any other suitable connectors. Connectors 58 and 66 may be the same type of connectors or may be different types of connectors. An illustrative example in which connectors 58 and 60 are based on USB (such as USB-C) connectors, is shown in FIG. 6B.

As shown in FIG. 6B, connectors 58 and 66 may both be openings with rectangular cross-sections, such as USB, USB-C, or lighting port openings, as examples. End portion 59 of lanyard 56 may have a corresponding portion to fit into the rectangular connector 58. For example, if connector 58 is a USB-C port, then end portion 59 may be a USB-C plug (also referred to as a USB-C connector herein). Alternatively, if connector 58 is a lightning port, then end portion 59 may be a lightning plug (also referred to as a lightning connector herein). However, these examples are merely illustrative, if desired, connector 58 may be any suitable connector, and end portion 59 may be any corresponding plug to fit into connector 58.

Connector 66 may be the same type of connector as connector 58, or may be a different connector. In an illustrative embodiment, connector 66 may have the same shape as connector 58 (e.g., the shape of a USB-C or lightning port), but may not have the electronic components associated with connector 58 (e.g., connector 66 may not have the traces and other components associated with a USB-C or lightning port). End portion 67 of lanyard 56 may be a USB-C or lightning plug that fits into connector 66, or end portion 67 may have the same shape as a USB-C or lightning plug without the electronic components to fit into connector 66. However, this example is merely illustrative. In general, connector 66 may be any desired type of connector, and end portion 67 may have a corresponding shape to be coupled to connector 66.

By forming connector 58 and/or connector 66 from USB-C port or lightning port, power and/or data may be transferred between input device 10 and lanyard 56. Additionally, device 10 may have a battery that is charged via connector 58 when lanyard 56 is not attached to device 10. When lanyard 56 is attached to device 10, the battery in device 10 may be used to power components in lanyard 56, such as light emitters 57, charge a battery in lanyard 56, and/or other input-output components in lanyard 56. In this way, lanyard 56 may receive power from device 10.

However, the arrangement in which lanyard 56 receives power from device 10 is merely illustrative. If desired, lanyard 56 may have its own battery to power components in lanyard 56. Alternatively, lanyard 56 may be tracked passively (e.g., using fiducials or high-contrast material) and not require power from a battery.

Returning to FIG. 6A, lanyard 56 may include features 68, which may include light emitters (such as light emitters 57 of FIG. 4A), fiducials (such as fiducials 59 of FIG. 4A), and/or high-contrast material (such as high-contrast fabric, polymer, and/or other material). An associated head-mounted device (or other device) may track lanyard 56 using features 68, as shown in FIG. 5.

By attaching lanyard 56 to two connectors 58 and 66, a portion of a user's hand (e.g., the user's fingers) may pass through opening 75 between input device 10 and lanyard 56 when it is desired to use lanyard 56 for tracking. Adjuster 64 may allow end portion 62 to be pulled through an opening of adjuster 64 and double back on itself. Friction between adjuster 64 and end portion 62, which may be enhanced using texture, such as ridges, on lanyard 56, may keep end portion 62 in place at adjuster 64. In this way, lanyard 56 may be tightened (e.g., opening 75 may be made smaller). By tightening lanyard 56, a tighter fit may be provided between lanyard 56 and the user's hand, and/or lanyard 56 may be tightened against input device 10 when being stowed.

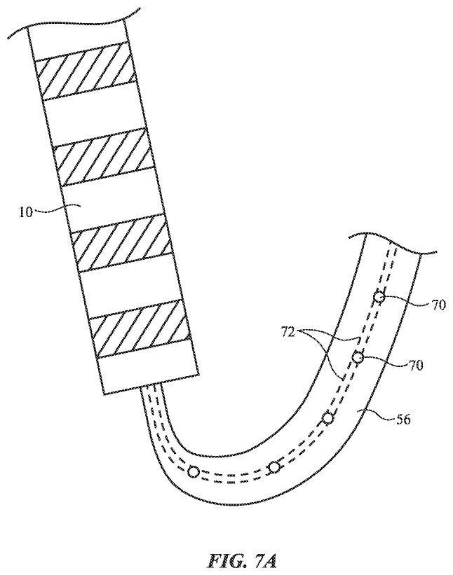

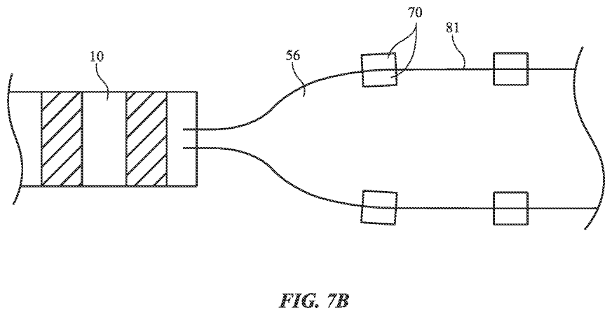

As discussed, lanyard 56 may include light emitters, such as infrared light emitters. An illustrative example of a lanyard having light emitters and wiring for those light emitters is shown in FIG. 7A.

As shown in FIG. 7A, lanyard 56 may be coupled to input device 10. Light emitters 70 (which may correspond to light emitters 57 of FIG. 4) may be coupled to a surface of lanyard 56, such as by using adhesive. Alternatively, light emitters 70 may be woven, knit, or otherwise coupled to fabric of lanyard 56. Light emitters 70 may be, as examples, infrared light emitters, infrared light-emitting diodes (LEDs), visible LEDs, or other suitable light-emitting components. Conductive material 72 may extend between light emitters 70. Conductive material 72 may be metal wires that are embedded with lanyard 56, as an example. Alternatively, conductive material 72 may be conductive strands that are woven, knitted, or otherwise incorporated into the fabric of lanyard 56. The conductive strands may be, for example, insulated copper strands.

Conductive material 72 may be coupled to input device 10. For example, light emitters 70 may receive power from input device 10 (e.g., from a battery in input device 10) and/or may be controlled by control circuitry in device 10. However, this is merely illustrative. Lanyard 56 may be a standalone device that powers and controls light emitters 70 (such as with a battery and control circuitry) without input from device 10, if desired.

An illustrative side view of lanyard 56 with light emitters 70 is shown in FIG. 7B. In particular, as shown in FIG. 7B, lanyard 56 may be formed from fabric (or other suitable material, such as polymer) 81. Fabric 81 may have opposing first and second surfaces, and light emitters 70 may be mounted to both sides of fabric 81. By mounting light emitters 70 on both sides of fabric 81, it may be easier to track light emitters 70 and therefore determine the location, orientation, and/or motion of lanyard 56 (e.g., if lanyard 56 is twisted or folded over on itself). Moreover, if desired, light emitters 70 may extend entirely around the fabric of lanyard 56. However, these arrangements are merely illustrative. Light emitters 70 may extend across one or both surfaces of fabric 81 and across any suitable portion of lanyard 56.

Although FIG. 7B shows light emitters 70 on both sides of fabric 81, this is merely illustrative. If desired, fiducials and/or high-contrast material may be mounted to or formed on both sides of fabric 81 instead of, or in addition to, light emitters 70.

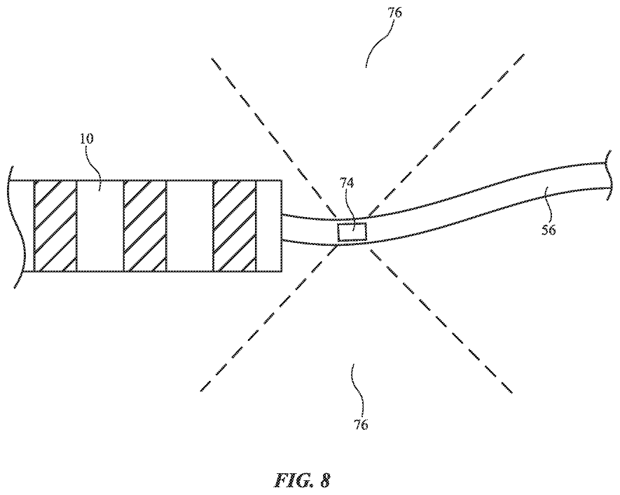

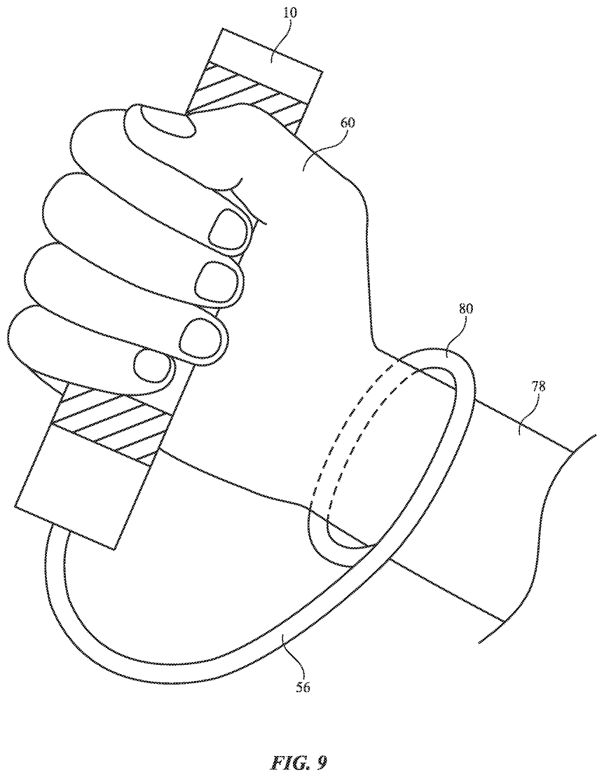

Lanyard 56 has been described as including portions that may be tracked by an external device, such as a head-mounted device, using circuitry in the external device. However, this is merely illustrative. In some embodiments, lanyard 56 may include components that can determine the location, orientation, and/or motion of lanyard 56. An illustrative example is shown in FIG. 8.

As shown in FIG. 8, lanyard 56 may include one or more visual-inertial odometry (VIO) cameras 74. VIO camera(s) 74 may include cameras in different directions. In the illustrative example of FIG. 8, VIO camera 74 may have a field of view defined by areas 76. However, this is merely illustrative. In general, VIO camera(s) 74 may have any suitable fields of view.

Images and/or image frames of video taken by VIO camera(s) 74 (or multiple fields of view of a single VIO camera) may be compared, such as by using image recognition, to determine a location and/or orientation of lanyard 56. Moreover, the images or image frames may be analyzed over multiple frames to determine a motion of lanyard 56. If desired, an IMU in components 61 may provide additional information regarding the location/orientation of lanyard 56. In this way, lanyard 56 may determine its own location, orientation, and/or motion. This information may be transmitted to an external device, such as a head-mounted device, via communications circuitry in lanyard 56, may be sent to input device 10 over a connector, such as the connector between device 10 and lanyard 56, or may be otherwise transmitted to another device. In this way, the location, orientation, and/or motion determined by lanyard 56 may be used as an input on an associated external device, such as a head-mounted device.

Although lanyard 56 has been described as providing information regarding the position of input device 10 or an external object to which lanyard 56 is connected, lanyard 56 may provide more direct information regarding the position of a user's body part. In particular, a lanyard that may be tracked by an external device or that may determine its own location, orientation, and/or motion may be coupled to a body part, such as a wrist or arm, directly. An illustrative example is shown in FIG. 9.

As shown in FIG. 9, while device 10 is held in hand 60, lanyard 56 may be wrapped around wrist 78 in loop 80. Therefore, by tracking light emitters, fiducials, and/or high-contrast material on lanyard 56, the location, orientation, and/or motion of wrist 78 may be determined. Alternatively or additionally, sensors in lanyard 56, such as one or more VIO cameras, may be used to determine the location, orientation, and/or motion of wrist 78.

Although FIG. 9 shows lanyard 56 wrapped around wrist 78, this is merely illustrative of a body part of which lanyard 56 can be used to determine a location, orientation, and/or motion.

In some embodiments, lanyard 56 may be extended to a user's arm and wrap around the user's bicep to provide location, orientation, and/or motion information of the user's arm. Alternatively, input device 10 may be held in hand 60, while lanyard 56 is held in or wrapped around the user's other hand to provide location, orientation, and/or motion information of the user's other hand. In some embodiments, for example, lanyard 56 and input device 10 may be connected while each is held, one in each hand. As a result, power and data may be transmitted between lanyard 56 and input device 10 (e.g., lanyard 56 may not require its own power source or control circuitry). If desired, however, lanyard 56 may have its own power source (e.g., a battery) and/or control circuitry, even if lanyard 56 and input device 10 are connected. In other embodiments, input device 10 may be held in hand 60, while lanyard 56 is held in or wrapped around the user's other hand, and input device 10 and lanyard 56 may be disconnected from one another. In these embodiments, lanyard 56 may have a standalone power source, control circuitry, and/or communications circuitry. For example, lanyard 56 may be in communication with input device 10 (or an associated head-mounted device). In general, however, any suitable body part may be tracked using lanyard 56.

Moreover, although not shown in FIG. 9, lanyard 56 may include one or more strain gauges (e.g., a strain gauge of components 61 of FIG. 4). Measurements from the strain gauges may be used to determine how tight lanyard 56 is on the user's wrist (or other body part). This information may be used to determine the accuracy the location, orientation, and/or motion measurements of the body part and/or may be used to alert a user to tighten or loosen the lanyard to provide more accurate measurements.

As described above, one aspect of the present technology is the gathering and use of information such as sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

1. A lanyard configured to attach to an external object and to provide input to a head-mounted device having a camera, the lanyard comprising:
a main portion;
an end portion coupled to the main portion, wherein the end portion is configured to attach to the external object; and
visual markers on the main portion, wherein the camera is configured to track a location of the lanyard using the visual markers.

2. The lanyard of claim 1, wherein the visual markers comprise infrared light-emitting diodes.

3. The lanyard of claim 2, wherein the main portion comprises fabric having opposing first and second surfaces, and the infrared light-emitting diodes are formed on the first and second surfaces of the fabric.

4. The lanyard of claim 3, further comprising:
conductive strands in the fabric that connect the infrared light-emitting diodes.

5. The lanyard of claim 4, wherein the conductive strands are configured to be electrically connected to the external object when the lanyard is attached to the external object.

6. The lanyard of claim 1, wherein the visual markers comprise fiducials on a surface of the main portion.

7. The lanyard of claim 6, wherein the fiducials comprise retroreflectors.

8. The lanyard of claim 6, wherein the main portion comprises fabric having opposing first and second surfaces, and the fiducials are formed on the first and second surfaces of the fabric.

9. The lanyard of claim 1, wherein the end portion is a first end portion coupled to a first end of the main portion, the lanyard further comprising:
a second end portion coupled to a second end of the main portion, wherein the second end portion is configured to attach to the external object.

10. The lanyard of claim 9, wherein the first end portion comprises a connector selected from the group consisting of: a USB-C connector and a lightning connector, and the lanyard is configured to receive power from the external object over the connector when the lanyard is attached to the external object.

11. The lanyard of claim 1, further comprising:
an inertial measurement unit coupled to the main portion.

12. The lanyard of claim 1, further comprising:
visual-inertial odometry cameras coupled to the main portion, wherein the visual-inertial odometry cameras are configured to determine the location of the lanyard.

13. The lanyard of claim 1, further comprising:
a haptic output device coupled to the main portion; and
a battery coupled to the main portion, wherein the battery is configured to be charged over a connector at the end portion.

14. The lanyard of claim 1, wherein the main portion is configured to be coupled to a wrist, and the camera is configured to track a location of the wrist using the visual markers.

15. The lanyard of claim 1, wherein the main portion is configured to be coupled to an arm, and the camera is configured to track a location of the arm using the visual markers.

16. The lanyard of claim 1, wherein the main portion is configured to be coupled to a hand, and the camera is configured to track a location of the hand using the visual markers.

17. The lanyard of claim 1, wherein the main portion comprises a fabric layer with embedded stiffeners.

18. The lanyard of claim 1, wherein the main portion comprises a plurality of links joined by friction fit joints.

19. A lanyard for an input device, wherein the lanyard is configured to provide input to a head-mounted device having a camera, the lanyard comprising:
a fabric layer;
a visual marker on the fabric layer, wherein the camera is configured to track a location of the lanyard using the visual marker; and
a connector at an end of the fabric layer configured to attach the lanyard to the input device.

20. The lanyard of claim 19, wherein the visual marker comprises an infrared light-emitting diode.

21. The lanyard of claim 19, wherein the visual marker comprises a fiducial.

22. The lanyard of claim 19, wherein the connector is configured to electrically connect the lanyard to the input device.

23. The lanyard of claim 22, further comprising:
a battery that is configured to charge over the connector.

24. A system, comprising:
a lanyard comprising a main portion, an end portion, and an infrared light-emitting diode on the main portion;
an external object, wherein the end portion of the lanyard is configured to attach to the external object; and
a head-mounted device configured to determine a location of the lanyard based on a location of the infrared light-emitting diode.

25. (canceled)

26. The system of claim 24, wherein the external object comprises an input device that is configured to provide an input to the head-mounted device.

27. The system of claim 24, wherein the external object comprises a non-electronic object.
